(19) United States
(12) Patent Application Publication
(10) Pub. No.: US 2008/0186255 A1
(43) Pub. Date: Aug. 7, 2008

(54) SYSTEMS AND METHODS FOR DATA ANNOTATION, RECORDATION, AND COMMUNICATION

(76) Inventors: Philip R. Cohen, Bainbridge Island, WA (US); David McGee, Bainbridge Island, WA (US)

Correspondence Address: BLACK LOWE & GRAHAM, PLLC, 701 FIFTH AVENUE, SUITE 4800, SEATTLE, WA, 98104, US

(21) Appl. No.: 11/952,896

(22) Filed: Dec. 7, 2007

Related U.S. Application Data
(60) Provisional application No. 60/869,093, filed on Dec. 7, 2006.

(51) Int. Cl. G09G 5/00; G06F 3/033

(52) U.S. Cl. 345/8; 345/179

(57) ABSTRACT

Systems, devices, and methods to provide tools enhance the tactical or strategic situation awareness of on-scene and remotely located personnel involved with the surveillance of a region-of-interest using field-of-view sensory augmentation tools. The sensory augmentation tools provide updated, visual, text, audio, and graphic information associated with the region-of-interest adjusted for the positional frame of reference of the on-scene or remote personnel viewing the region-of-interest, map, document or other surface. Annotations and augmented reality graphics projected onto and positionally registered with objects or regions-of-interest visible within the field of view of a user looking through a see through monitor may select the projected graphics for editing and manipulation by sensory feedback from the viewer.

### PRIORITY CLAIM

This application claims priority to and incorporates by reference in its entirety U.S. Patent Provisional Application No. 60/869,093 filed Dec. 7, 2006.

### FIELD OF THE INVENTION

The invention relates generally to a system for providing information by displaying the information onto a reference frame, and specifically relates to a system for interpreting symbolic information that may be revised, overlaid or otherwise manipulated on a substantially real-time basis relative to the reference frame.

### BACKGROUND OF THE INVENTION

Interfaces for field use employing conventional Graphical User Interfaces (GUI) are intended to enhance or increase a soldier's or rescue personnel's situational awareness under combat or other hazardous circumstances. Conventional GUI's elements and design strategies can require a considerable amount of heads-down time, especially when the interface is a display screen of a laptop computer or the tiny screen of a personal data assistant (PDA) that presents clustered data or images difficult to discern. Such interfaces often place too much burden on the user's cognitive system, distracting them from their task that requires substantial situation awareness, especially under high-risk situations. The heads-down time is in proportion to the time spent in viewing and comprehending GUI presented information and manipulation of interface elements or devices in presenting or retrieving information for display by the GUI. The heads down time associated with gazing at the GUI and that expended by a soldier manipulating the interface device can decrease a soldier's situational awareness, contraindicating the intended purpose of the field deployed GUI and associated interface devices. Existing systems employing ink-on-paper documents often require dedicated personnel to transcribe the inked annotations into command post computers, often resulting in tardy dissemination to deployed personnel of tactical information that, due to its late delivery, does not improve situational awareness.

Other interfaces include a three dimensional appearance but are based on specialized holographic films and highly coherent light sources, for example lasers, that are not readily amenable to presenting dynamically changing images requiring high refresh rates in that the three dimensional images need to be reassembled by recombination of coherent light sources.

Another problem with conventional interfaces for field use is that input and output mechanisms conventionally used have been awkward and not multifunctional. They also prevent users from operating a system without interrupting their tasks, which may be dangerous or not possible. In military combat scenarios, current battlefield systems are based around the graphical user interface, with windows, icons, mouse-pointer, and menus that take up a soldier's time, attention, and decreases situational awareness. For the task of updating a patrol route, current practices can be limited and in some cases be susceptible to communication errors resulting with information update delays of multiple minutes or longer.

### SUMMARY OF THE INVENTION

Systems, devices, and methods to provide tools enhance the tactical or strategic situation awareness of on-scene and remotely located personnel involved with the surveillance of a region-of-interest using field-of-view sensory augmentation tools. The sensory augmentation tools provide updated, visual, text, audio, and graphic information concerning the region of interest and projects and registers onto the map, document, or other surface with adjustments made for the positional frame of reference or vantage point of the on-scene or remote personnel viewing the projected content on the region-of-interest.

In one embodiment, the system may interpret and then convert symbolic representations of an object into real life depictions of the object and then display or otherwise project these depictions onto a substantially transparent display device or upon information containing surfaces, for example a paper-based document, visible to at least one observer. The real life depictions may be selected for editing and manipulation by sensory input from the viewer, such as voice commands and hand gestures.

In one aspect of the invention, a symbol in proximity to an information-carrying surface having fiducial reference markers is generated and transmitted to a processor. After processing, the symbol is converted to a realistic depiction representative of the symbol, and the realistic depiction is conveyed for displaying to a display device.

### BRIEF DESCRIPTION OF THE DRAWINGS

Preferred and alternative embodiments of the present invention are described in detail below with reference to the following drawings:

FIG. 1 schematically illustrates an embodiment of a data annotation, recordation and communication system utilizing a helmet mounted transparent display in signal communication with the digital pen;

FIG. 2 schematically illustrates an embodiment of a data annotation, recordation and communication system utilizing non-transparent display in signal communication a non-transparent computer monitor that in turn is in signal communication with the helmet mounted transparent display;

FIG. 3 schematically illustrates an alternate embodiment of system 10 illustrated in FIG. 2;

FIG. 4 illustrates a cross-sectional view of the digital pen data dock of FIG. 3;

FIG. 5 schematically illustrates a patternized paper substrate combinable with a paper based map;

FIG. 6 schematically illustrates the paper based map merged with the patternized paper substrate and a magnified inset of the merged paper and patternized substrate;

FIG. 7 schematically illustrates a method of using an embodiment of data annotation, recordation, and communication system;

FIG. 8 schematically illustrates augmented reality symbols projecting onto a paper map as seen from the vantage of a first viewer;

FIG. 9 schematically illustrates the symbology projected onto the paper map of FIG. 8 as seen from the vantage of a second viewer;

FIG. 10 schematically illustrates a sunglass configured helmet mounted display in signal communication with the digital pen of FIG. 1 conveying hand annotations to the sunglass display;

FIG. 11 schematically illustrates hand activation zones of a computer display;

FIG. 12 schematically illustrates a projected cityscape onto a paper map undergoing hand and/or voice manipulation of projected objects by a nearby user viewing the projected cityscape as appearing from the vantage of the user gazing through the transparent window 74 of helmet mounted display 70; and

FIG. 13 schematically and pictorially illustrates an expanded system block diagram for annotating, recording, and communicating information.

### DETAILED DESCRIPTION OF THE PARTICULAR EMBODIMENTS

In one embodiment, the present invention relates generally to a system having augmentation tools to provide updated information, such as, but not limited to visual, textual, audio, and graphical information, where the information may be associated with a remotely located region-of-interest and by way of example, the information may be received from a digital pen. The augmentation tools operate to receive and then project or otherwise display the information onto a reference frame, for example a fixed reference frame such as a table or other surface. In one embodiment, a viewer of the information may change locations relative to the reference frame and at least one feature of the augmentation tools provides the viewer with an updated view of the information based on the viewer's changed location.

In one embodiment, the augmentation tools may be employed within differently configured systems having fiducial reference markings that are bound by a surface that may include a micro-pattern, a macro-symbology pattern, or both. In such an embodiment, movement of a digital pen may be tracked using the micro-pattern and the larger human-perceptible symbols. The movement may be viewed, tracked, and captured in a series of images using an image capturing device, such as a digital camera. The symbols may then be processed using a microprocessor and then displayed or projected onto a display device.

In another embodiment, a substantially planar surface is equipped with fiducial markers to designate orientation points to establish a positional reference system for the substantially planar surface. The fiducial markers may reside along the periphery of the planar surface and/or within the planar surface. A digital pen having an on-board image capture device, a processor to receive signals from and instructions for processing image signals from the image capture device, a memory to store the processed signals, a communication link to transmit the processed signals, and a surface inscriber is maneuvered by a user to apply sketches upon the planar surface at locations determined through orienteering algorithms applied to the fiducial markers.

The inscriber of the digital pen may include an ink dispensing stylus, roller ball, felt tip, pencil carbon, etching solution, burr or cutting edge and the sketches applied to the surface may include standardized symbols, alphanumeric text annotations, drawn pictures and/or realistic depictions of objects. The planar surface may be the face of a table, a side of a box, a map, a document, a book page, a newspaper or magazine page, or any information carrying surface capable to receive ink or other marking materials or inscribing actions. The planar surface may be substantially horizontal, or positioned in angled increments from the horizontal towards a vertical alignment. The planar surface may be curved. Other embodiments may include applying the fiducial markers to hemispherical, spherical, and the surfaces of polygonal shapes conducive to receive the inscribing action of the digital pen.

A plurality of images of the sketch are captured by the image capture device and the location of the digital pen relative to the planar surface is determined by data obtained by the orienteering processes within the digital pen processor. The image capturing device may include an onboard still camera configured to acquire a rapid succession of serial images, a scanner, or a digital movie camera. The camera optics may utilize complementary metal-oxide semiconductor (CMOS) image sensors or a charge coupled device (CCD) image sensor. The captured and processed images may be stored within the pen, retrieved, and conveyed by wireless means to the microprocessor-based display, or alternatively, conveyed through a digital pen docking station in signal communication with the microprocessor-based display for additional processing apart from the digital pen.

The microprocessor-based display may include a substantially transparent screen or window that is wearable over an eye or eyes of an observer, for example in the form of a helmet mounted display (HMD), a heads up display (HUD), or a sunglass-appearing monitor. The screen of the HMD, HUD, or sunglass-appearing monitor may convey images of the duplicated sketch as from light-attenuating liquid crystal interface layer built into the substantially transparent window or as reflections visible to the observer from projections cast upon the substantially transparent window configured with a partially reflective surface or optical coating. Duplicated sketches conveyed to the liquid crystal interface layer or projected onto the partially reflective coatings appear visible to the observer without substantially altering or blocking the remaining portions of the observer's field of view available within the substantially transparent screen or window of the HUD or sunglass-appearing monitor. In yet other embodiments the HUD or sunglass-appearing monitor may employ rotating mirrors or mirrors that pivot into position to that duplicated sketches are projected and appear within a portion of the observers' field of view.

The sketches traced by the digital pen may include standardized symbols having recognizable shapes that are compared with shapes stored in memory files or lookup lists or tables to serve as a basis to interpret the symbolic information. Shapes from the lookup tables that match the digital pen sketched shape are selected and may be speech announced or substituted with an icon or realistic depiction having definitional meaning consistent with the sketched annotation symbol. Templates concerned with military endeavors, for example the icons or symbols described by Military Standard 2525b, or those icons or symbols relevant to civilian emergencies requiring crisis management implementations may be stored in memory and matched to a particular sketched shape drawn by the digital pen. Other shape templates for the medical, civilian engineering, electrical engineering, architecture, power plant, business, aeronautical, transportation, and the computer and software industries can be similarly stored in memory of a computer system in signal communication with the digital pen. The digital pen sketched symbols may be matched against the repertoire of image symbols store in the computer system. The recognized sketches of the templates can be advantageously displayed by projection means or within the liquid crystal interface.

Alternate embodiments of the fiducial markers may include arrays of printed microdots located along at least a portion of the periphery of the planar surface to assist orienting the position of the digital pen relative to the position of a heads up display or helmet mounted display with a line-of-site view to the information carrying surface. In cases when the planar surface is a document, for example a map, the fiducial markers may be self-defining in that reference figures of the document, for example Cartesian coordinates or Polar coordinates, or other geographic markers, serves as a basis to provide orientation to the digital pen. Other fiducial markers located along at least a portion of the periphery that may include stylized symbols that are coded or orienting the digital pen and/or the helmet mounted display having a line of site view of the information carrying surface. Yet other fiducial markers may employ pressure sensors, charge sensor, magnetic, and/or sound sensors that are responsive to motion, static charge, magnetic fields and sound energy capable of detection for establishing reference loci for the information carrying surface.

Dot patterns contained within the perimeter of the information carrying surface provides an orientation basis of the digital pen's location relative to the information carrying surface.

Other embodiments of the fiducial markers may also include fiducial markers applied to the transparent monitor such that the position of the transparent monitor may be oriented with regards to the planar, hemispherical, spherical, curved, or other surface undergoing inscription by the digital pen. This provides the ability to do position tracking or orientation of the digital pen and the substantially transparent monitor relative to the surface. This multi-tracking ability allows the duplicated and displayed sketches to be presented with oriented accuracy relative to the surface, and with regards to the orientation of the substantially transparent monitor or window through which an observer views the planar surface. In this way the displayed sketches projected upon the viewing monitor surface or within the monitor surface is presented or displayed with regard to a given observers vantage point or positional frame of reference relative to the surface. In this way multiple observers, each wearing their own substantially transparent monitors but in different positions relative to the opaque, information carrying surface, receive augmented sketches that are projected with positional fidelity to the substantially transparent screen of the helmet mounted display surface and with orientation accuracy to the vantage point of each observer.

Other systems provide for the overlay or projection of sketches prepared by augmented reality processes that are presented on the planar or other shaped surface with a three dimensional appearance. Similar to the digitally recreated two dimensional augmented sketches projected onto or appearing within the substantially transparent displays, the three dimensional appearing symbology may be vantage corrected to the particular viewing position of the observer to the planar or other information carrying surface. The augmented reality processes may utilize the ARToolKit. The ARToolkit provides a software library that may be utilized to determine the orientation and position of the image capture device of the digital pen and of the substantially transparent monitor. Calculations based upon the fiducial markers located on the planar or other information carrying surface and on the substantially transparent monitor provide the basis for orienting the digitally reproduced augmentation within the information carrying surface and orienting the digitally reproduced augmentation relative to the vantage frame of reference of the observer wearing the substantially transparent monitor. The calculations may be determined from these fiducial markers in near real time. The ARToolKit is available from ARToolworks, Inc., Seattle, Wash., USA.

The augmentation tools may take the form of a rotatable eye-piece positioned over an eye of the viewer, a helmet-mounted display worn by the viewer and adjusted for the positional frame of reference of the on-scene or remote personnel. Content from the sensory augmentation tools is manipulatable, editable, storable, retrievable and exchangeable between on-scene and remote personnel using voice, and remote touch procedures. Content includes near-simultaneous annotation, self-identifying symbology or symbols projected within the field of view that includes information deemed pertinent to the region-of-interest undergoing surveillance. Applications for these tools include crisis management situations under civilian and/or military related circumstances, or to enhance collaboration between groups of observers commonly viewing a region of interest, a substantially planar surface, or other viewable space amenable for visual augmentation.

The annotations and augmented reality information is registerable to a map, document, or other surface and is projectable upon the map, document and surface within the field of view and becomes a sensory medium available for viewing, editing, interaction, and manipulation by the viewing personnel and for wireless sharing between viewing personnel and digital recordation in off site databases. Annotations and symbology projected onto maps, documents or surfaces as recognition results may be voice and remote touch manipulated or highlighted to emphasize certain features designated having informative value and presented to each on-scene or remote personnel viewing the region-of-interest adjusted to their particular frame of viewing reference.

The illustrations and descriptions also describe systems, devices, and methods that provide tools to personnel or organizations undergoing crisis management scenarios in which enhanced situation awareness is provided to on-scene and remotely located personnel requiring updated tactical and strategic information. The tools provide two-way communication between on-scene and remote personnel and the ability to generate, visualize, recognize, manipulate and otherwise sense updated tactical and strategic information having visual, aural, audio, and augmented with self-identifying graphic objects that are sensed by the viewing on-scene and remotely located personnel in accord with their particular positional frame of reference to a given region-of-interest.

Particular embodiments provide for on-scene personnel having an uninterrupted sensory view of a region of interest that is augmented with the updated tactical and strategic information. The presentation of the augmented information is editable by voice command, movement and other viewer-selected interaction processes and sensed within spatial fidelity to the on-scene personnel's positional frame of reference of the region of interest being viewed. The presentation of content of the augmented information projected within the viewing surface of a see through monitor positioned over the eye of a user. The see through monitor or transparent monitor may be part of a helmet mounted display or sunglasses to conceal the monitor. The user gazes through in the head wearable or sunglass-configured monitor having the projected annotations and graphics to provided information augmentation to the scene or surface being examined. When discretely viewed, surreptitious editing of projected icons, graphics, text and/or hand annotations may be undertaken and augmented with recorded commentary and communicated between on-scene personnel and on-scene and remotely located personnel. The systems, methods, and devices may utilizing a digital pen having an onboard scanner, onboard computer-based memory, an ink cartridge, and a communications link to a user-wearable computer-based monitor or other monitor positioned to be viewable by a user and thereby provide timely and enhanced situation awareness to the user are described.

Disclosure detailed below also provides for several system and method particular embodiments for annotating, recording, and communicating information, especially configured to provide near simultaneous updating of tactical and strategic information to enhance a user's situation awareness. Systems and methods utilizing digital pen having an onboard scanner, onboard computer-based memory, an ink cartridge, and a communications link to a user-wearable computer-based monitor or other monitor positioned to be viewable by a user and thereby provide timely and enhanced situation awareness to the user are described.

The digital pen annotates paper based and other substrates capable of receiving ink and the onboard scanner captures the annotated alphanumeric, sketches, or other pictographic information that is storable in the computer-based memory and retrievable from memory for near simultaneous dissemination to the user-wearable monitor. The paper-based substrates, in alternate embodiments, may have a patternized under layer or co-layer to furnish reference coordinates to the alphanumeric and pictographic annotations. The annotated information is sent from memory by wireless or wired communication to the computer based monitor. The computer-based monitor includes helmet mounted transparent or see through displays that present the annotated information while not obstructing the helmet wearer's view of the indoor or outdoor spaces to which enhanced situation awareness is required.

Included in the system are the use of paper maps or other portable objects that serve as surface objects for the projection and registration of virtual, large, coordinated, and collaborative digital field displays and input screens or mediums. The projected and registered digitally augmented graphic objects allow a user to rapidly annotate information having strategic and/or tactical importance so that personnel involved with fast paced activities can spend less time transcribing and more time devoted to action. The projected displays may include digital maps to provide high-resolution maps/photographs of varying physical sizes and scales that can be seen by others adorning the substantially transparent monitor similar to monitor 70 and positionally adjusted to their respective vantage point or frame of reference. This allows the ability to collaborate naturally with colleagues. The digital tools for obtaining the near instantaneous updating of strategic and/or tactical information requires minimum training and test procedures in that it is readily adaptable by users and only requires the users employ a natural interface of hand sketching or writing, and in some cases, to speak.

The paper maps or other portable mediums upon which annotations are made employ a digital pen having an onboard scanner, an onboard computer-based memory, an ink cartridge, and a communications link to a computer-based monitor. The digital pen annotates paper based and other substrates capable of receiving ink and the onboard scanner captures the annotated alphanumeric, sketches, or other pictographic information that is storable in the computer-based memory. The paper-based substrates, in alternate embodiments, may have a patternized under layer or co-layer to furnish reference coordinates to the alphanumeric and pictographic annotations. The annotated information is sent from memory by wireless or wired communication to the computer based monitor. The computer-based monitor includes helmet mounted transparent or see through displays that present the annotated information while not obstructing the helmet wearer's view of the indoor or outdoor spaces to which enhanced situation awareness is required.

Other embodiments provide for a digital pen having an onboard scanner, onboard computer-based memory, an ink cartridge, and a communications link to a computer-based monitor. The digital pen annotates paper based and other substrates capable of receiving ink and the onboard scanner captures the annotated alphanumeric, sketches, or other pictographic information that is storable in the computer-based memory. The paper-based substrates, in alternate embodiments, may have a patternized under layer or co-layer to furnish reference coordinates to the alphanumeric and pictographic annotations. The annotated information is sent from memory by wireless or wired communication to the computer based monitor. The computer-based monitor includes helmet mounted transparent or see through displays that present the annotated information while not obstructing the helmet wearer's view of the indoor or outdoor spaces to which enhanced situation awareness is required.

Alternate embodiments include non-transparent computer-based monitors that in turn may further process the captured hand annotations and relay the processed hand annotations to the helmet mounted transparent monitors. Other alternate embodiments include additional processing using augmented reality, hand activation and manipulation of monitor displayed objects, icons, or regions of interest. Other particular embodiments include microphone delivered voice input modifications of or commentary to information associated with hand annotations, icon presentations, and other monitor-presented region or point of interest information.

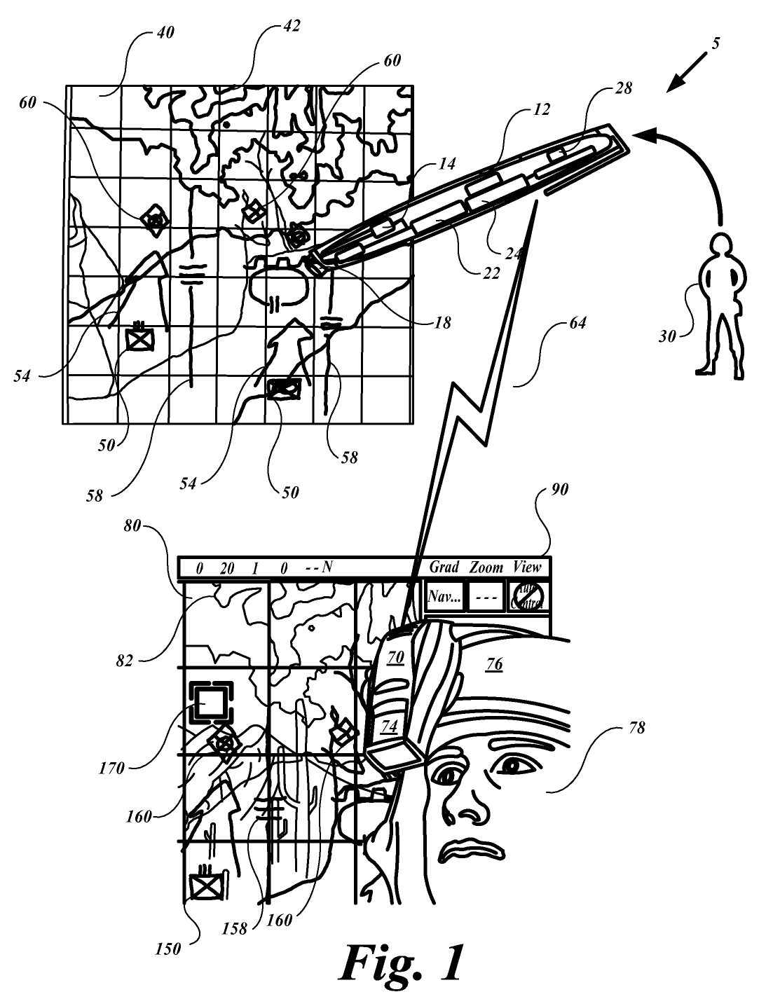

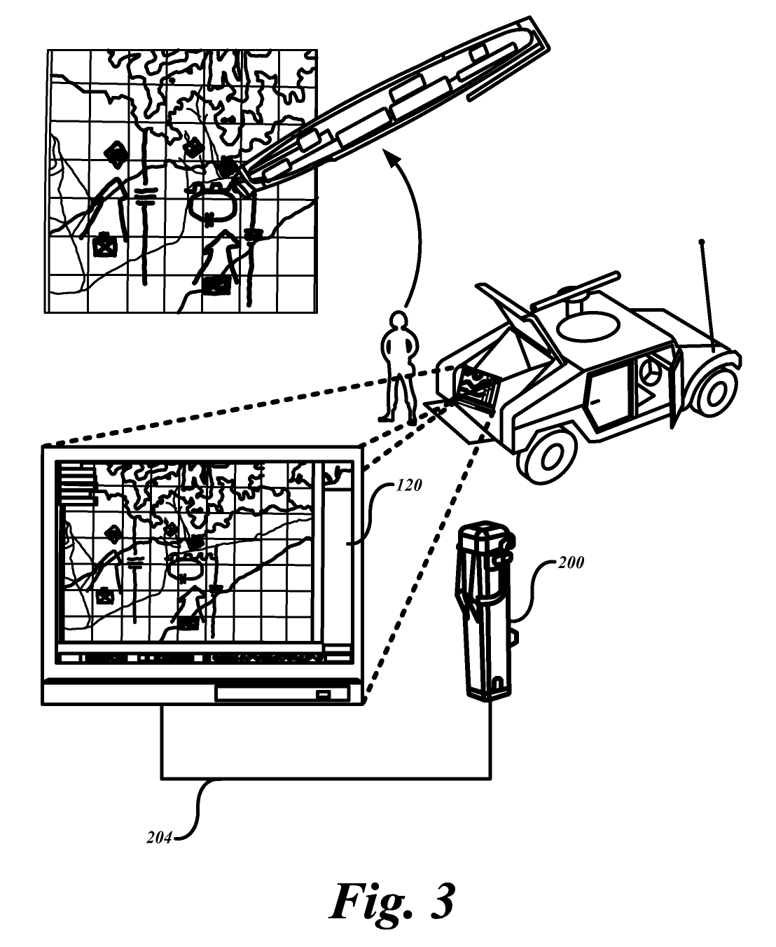

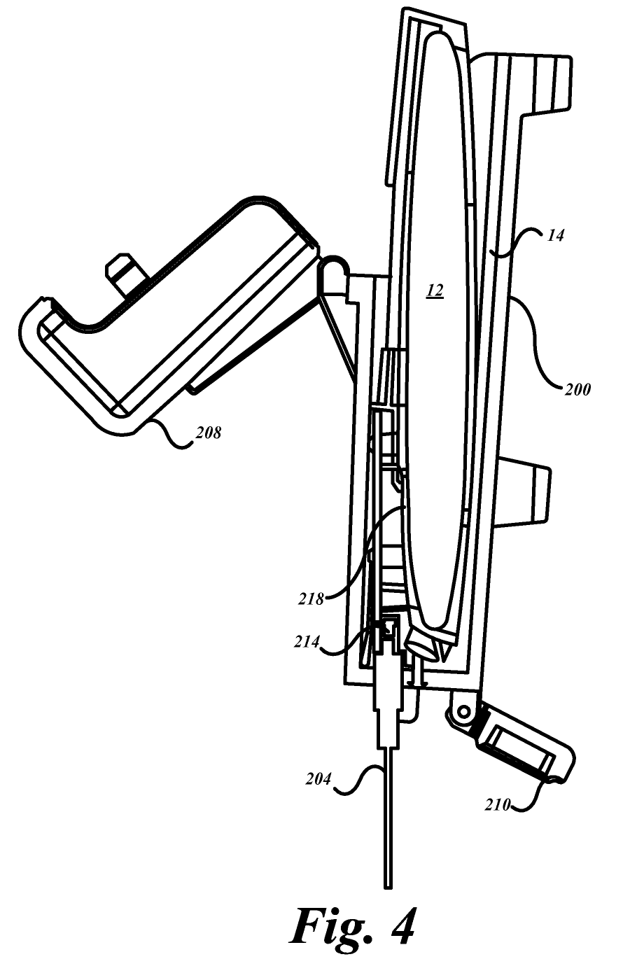

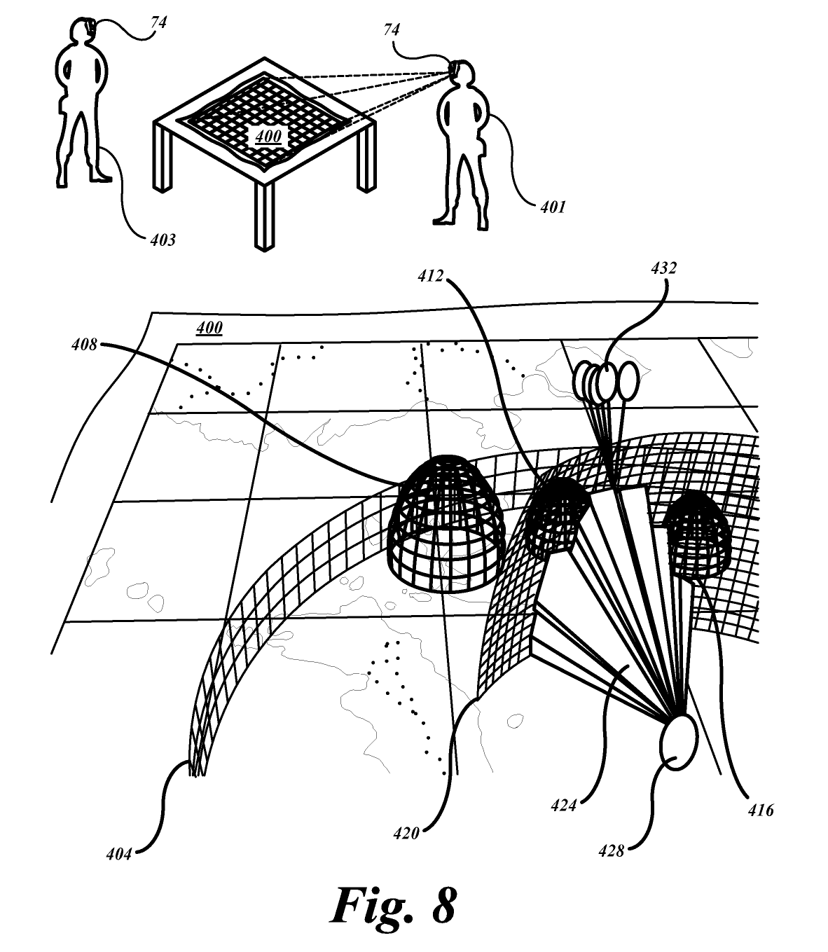

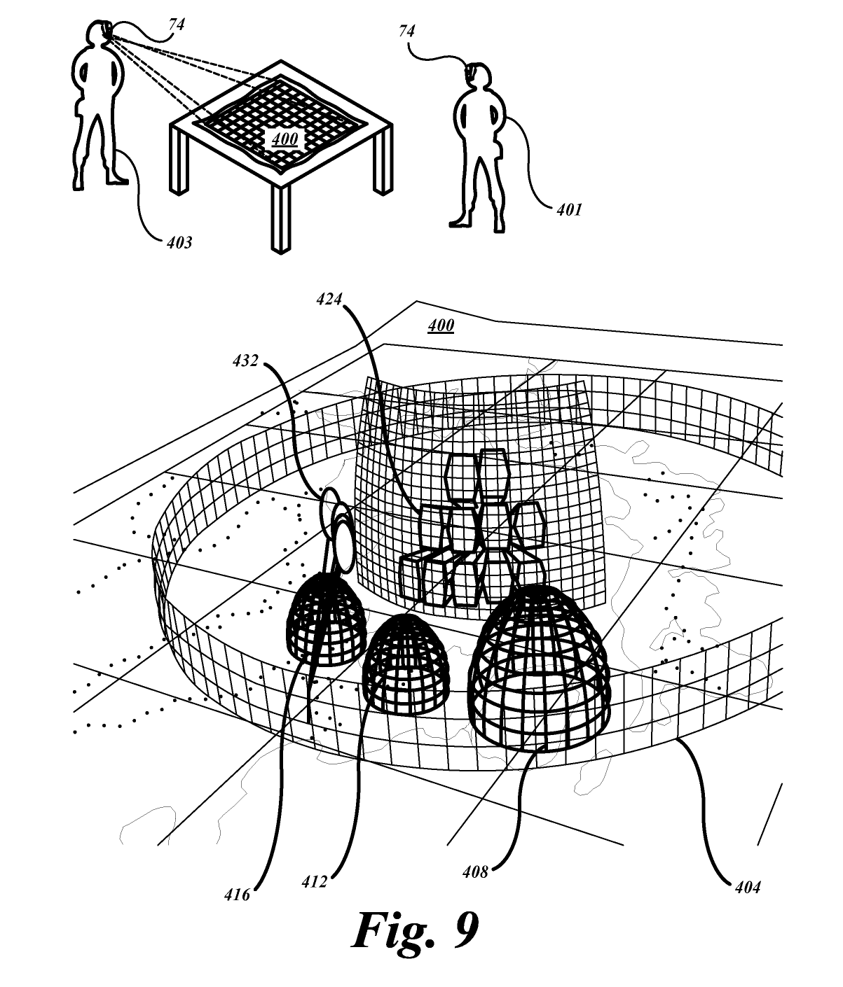

FIG. 1 schematically illustrates a data annotation, recordation and communication system 5 utilizing a helmet mounted transparent display 70 in signal communication with a digital pen 12. The digital pen 12 functions as a writing or sketching instrument and includes an ink cartridge 14 having a roller tip, felt tip or other ink distributing mechanism. The electronics of the digital pen 12 includes a battery 12, a camera 18, a processor 22, a memory 24, and a wireless transceiver 28. The wireless transceiver 28 may incorporate a Bluetooth transceiver. The digital pen 12 is manipulatable by a user 30 and is shown engaging with a paper-based map 40 having points-of-interest (POI) 42. By way of example, the POI 42 may include elevation contour lines, buildings, reservoirs, lakes, streams, roads, utility power stations, military bases, map coordinates, geographic coordinates, or other regions-of-interest (ROI) information. The ink distributing mechanism of the ink cartridge 14 is shown making annotations 50, 54, 58, 60 made by the user 30 upon the surface of the paper-based map 40. Annotations 50, 54, 58, and 60 are within the field of view of the camera 18 that snaps or rapidly acquires a series of images of the annotations 50, 54, 58, and 60 while they are being sketched or drawn on the paper-based map 40 by the user 30. The positions of the annotations 50, 54, 58, and 60 in relation to the surface of the paper based map 40 may be determined by on board accelerometers and velocimeters (not shown) or by a registration pattern located within the paper map 40 as described for and illustrated in FIGS. 3 and 4 below. The registration pattern is discernable by the optics and associated electronics of the camera 18 as described for FIG. 3 below. A wireless signal 64 is transmitted by the wireless transceiver 28 to a helmet mounted display (HMD) 70 detachably affixed to a helmet 76 of a wearer 78 deployed distantly from the locale from which the map annotations were created by the user 30. The HMD 70 may include a see through or transparent monitor window 74 and a memory (not shown) and operating system that permits a stored digital map file 80 to be retrievable from the HMD 70's memory by the wearer 78, and may be multimodal configured to view augmented reality interfaces described in FIGS. 8-9 below. The retrievable digital map file 80 duplicates the non-annotated POI 42 information of the paper-based map 40 in the form of an electronic POI 82 equivalent.

The paper-based map's 40 annotations (50, 54, 58, and 60) are updated with the digital map file 80 and overlaid upon the transparent monitor window 74 but in a way that does not substantially obscure the field of view of the wearer 78. The field of view includes the terrain in which the wearer 78 resides in, here depicted as an expanse of cactus borne desert. The digital map file 80 is updated with image annotations 150, 154, 158, and 160 that are the digital image equivalents of the paper-based map 40 annotations 50, 54, 58, and 60. The image annotations 150, 154, 158, and 160 are located with geographical fidelity to the POI 82 of the digital map 80 as the annotations 50, 54, 58, and 60 are located with geographical fidelity to the POI 42 of the paper-based map 40. Overlaid upon or within the transparent monitor window 74 is information toolbar 90 having subsections displaying map coordinates (0, 20, 1, 0, N), view type (gradient, zoom), Navigation panel (Nav), and Control Status, here illustrated with a negative circle drawn over the phrase “Auto Control” indicating that auto control was not engaged. A magnification window 170 may be operationally under control by the wearer 78 to select a selected POI 82 of the digital map 80 to expand subsections thereof for examination of finer detail within the selected POI 82.

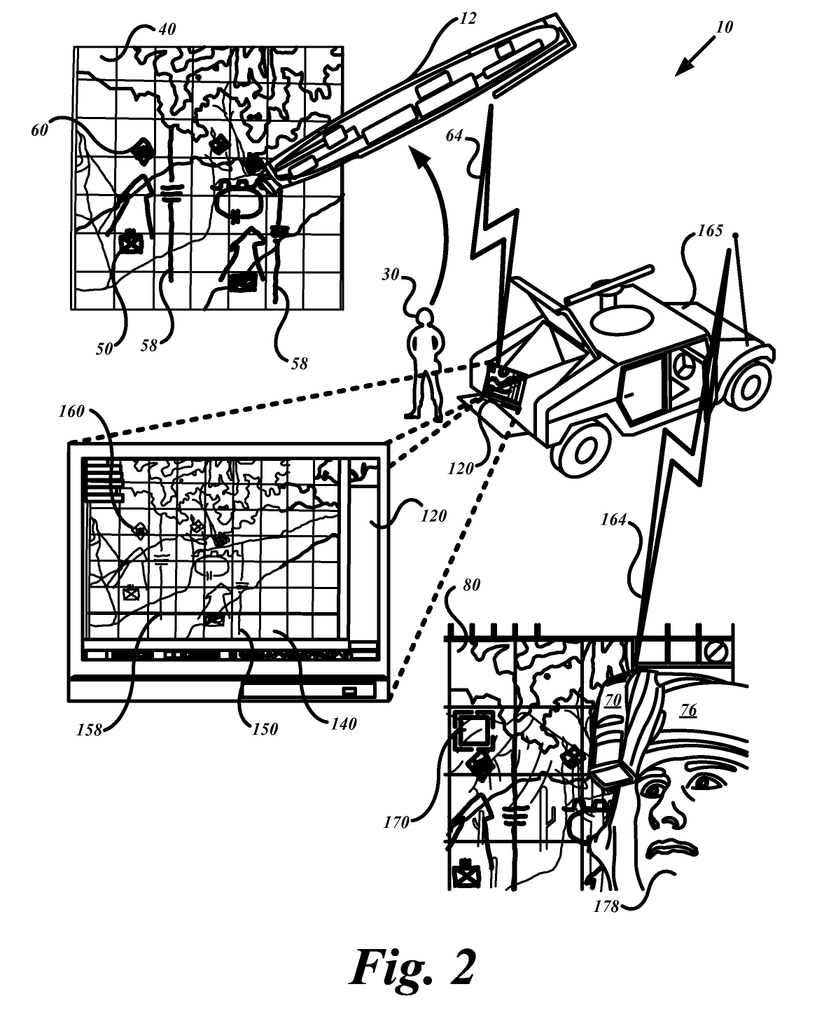

FIG. 2 schematically illustrates an exemplary alternate embodiment 10 of a data annotation, recordation and communication system utilizing a computer system 120 in signal communication digital pen 12 in a military battle force tactical (BFT) scenario. Though described in a military scenario, the following descriptions are not limited to military applications, but can equally apply to civilian circumstances, such as architectural design. As depicted here, the computer system 120 operates as a command and control personal computer (C2PC) and provides interoperability or compatibility with force battle command brigade and below (FBCB2) and command post of the future (CPOF). The computer system 120 may similarly operate in civilian organizations in similar circumstances to convey replications of annotations or digital objects to augment the scene being viewed by multiple personnel. The computer system 120 has substantial processors, memory storage and an operation system to allow retrieval of digital map files for updating with the hand annotations made by the user 30 on digital paper described in FIGS. 3-4 below to support command and control computer-based communication operations (C4) and to update centralized databases.

Similar in operation to system 5, system 10 conveys map annotated information, for example annotations 50, 54, 58, and 60 to a display 160 of computer system 120, wherein matching map files are updated with the hand annotations 50, 54, 58, and 60 made by the user 30. Here the computer system 120 may be located with a vehicle or forward operations base (FOB) 165 configured to operate the computer system 120. From the FOB 165, the wearer 78 may receive a new memory file of the digital map 80 with the updated image annotations 150, 154, 158, and 160 via signal 164 conveyed from the FOB 165 in signal communication with the computer system 120. Alternatively, the helmet mounted display 70 stored digital file 80 may be revised with the updated image annotations 150, 154, 158, and 160 via content delivered through the signal 164. In other embodiments, the computer system 120 may wirelessly convey the map image annotations 150, 154, 158, and 160 directly to the helmet mounted display 70 for updating a pre-stored digital map file, or receive a new digital file of the map 80 with the updated image annotations 150, 154, 158, and 160.

FIG. 3 schematically illustrates another exemplary alternate embodiment of system 10 illustrated in FIG. 2. Here a digital pen docking station 200 is shown in wired communication with the computer system 120. Under circumstances when the user 30 prefers or is otherwise required to convey signal transmission under more secure conditions, the digital pen 12 is placed in signal communication with the docking station 200. Image annotations 150, 154, 158, and 160 via signal cable 204 are conveyed from the digital pen 12 to the computer system 120 operating near the FOB 165. The signal cable 204 may include USB, Firewire, parallel and serial port configurations. Within the computer system 120, map annotated information, for example hand annotations 50, 54, 58, and 60 in the form of image annotations 150, 154, 158, and 160 are presented on display 160 wherein matching map files are updated, or alternatively, new map image files are made with the image annotations 150, 154, 158, and 160.

Alternate embodiments of the systems and methods illustrated above and below provides for face-to-face and remote collaboration between helmet mounted display 70 wearers 78 or users 30 operating the digital pens 12 and computer systems 120. The face-to-face collaboration occurs between different users 30 having their own digital pens 12 and using shared paper maps 40. Each user 30 can employ their own digital pen 12, and they can view either the same or different information overlaid on the map 40. Each user 30 can see the annotations from their viewpoint on the paper map 40. The system can also support distributed, collaborative use with remote helmet mounted display 70 wearers 78. In these instances, the different helmet mounted display 70 wearers 78 can collaborate using speech, sketch, hand gestures, and overlaid information. Remote dismounted users can see each other's annotations overlaid in their own HMD/HUD 70 see-through displays rendered on their own paper map 40 or on the terrain seen within the see-through monitor 74.

FIG. 4 illustrates a cross-sectional view of the digital pen data docking station 200 of FIG. 3. Upper lid 208 is pivoted open to permit the seating of the digital pen 12 within the interior of the docking station 200. Lower lid 210 is pivoted open to permit the connection of the signal cable 204 with electrical contact 214 of the docking station 200. The electrical contact 214 may be configured to be compatible with USB, Firewire, parallel and serial configured cables. Circuit board 218 makes electrical connection to the memory 24 via external contacts (not shown) of the digital pen 12 signal to retrieve the image files having the scanned images of image annotations 150, 154, 158, and 160 for conveyance to the cable 204 via electrical contact 214. Also illustrated are replacement ink pens 14 stored in slots within the interior of the docking station 200.

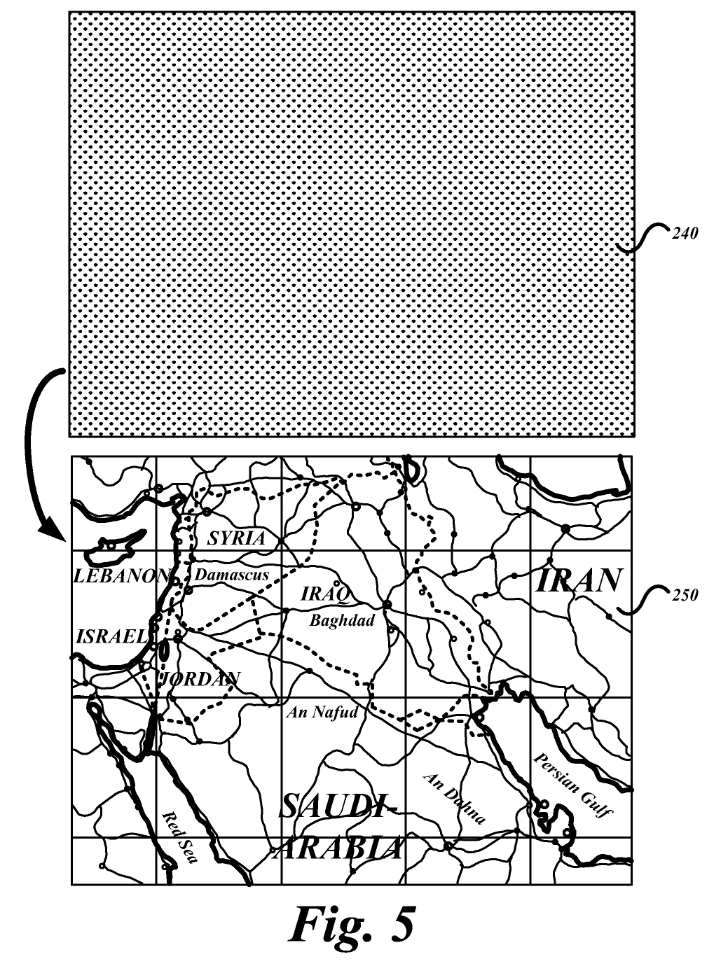

FIG. 5 schematically illustrates a substrate having a pattern array 240 combinable with a paper based map 250. The pattern array 240 includes a plurality of dots or other designs or indicia visible by the scanner 18 of the digital pen 12. The pattern array 240 may include the Anoto pattern described in U.S. Pat. Nos. 6,836,555, 6,689,966, and 6,586,688, herein incorporated by reference in their entirety. The array 240 consists of an array of tiny dots arranged in a quasi-regular grid. The user 30 can write on this paper using the digital pen 12 configured with the Anoto pattern. When the user 30 writes on the paper, the camera 18 photographs movements across the grid pattern, and can determine where on the paper the pen has traveled. In addition to the Anoto pattern, which can impart a light gray shading, the paper itself can have anything printed upon it using inks that does not affect the visibility of the scanner 18 to discern the array 240. In addition to maps, other paper-based application, for example, structured forms may be use with the pattern array 240.

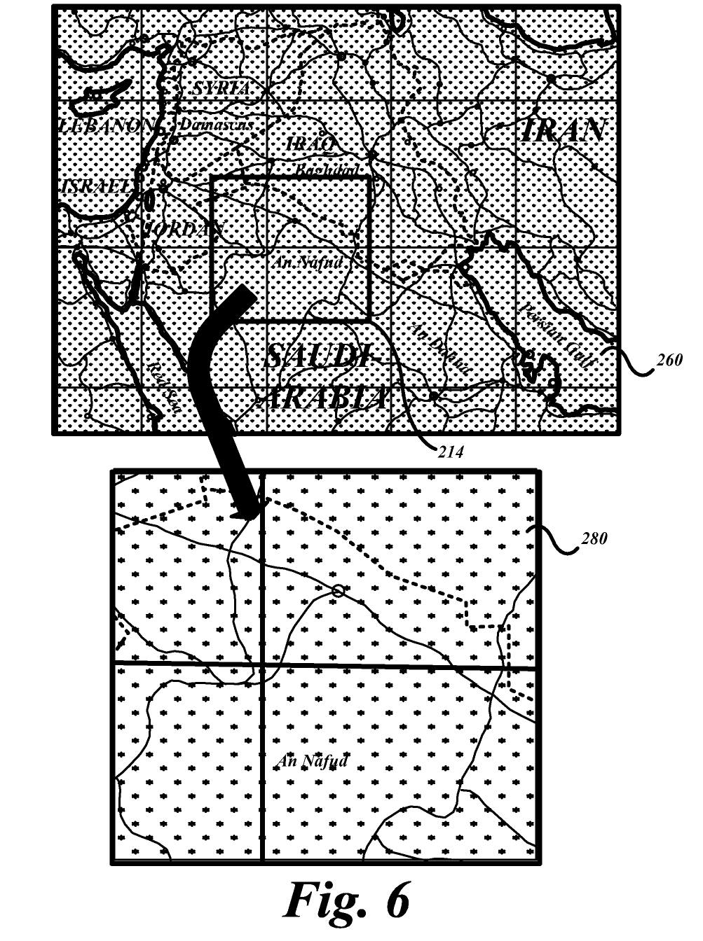

FIG. 6 schematically illustrates the paper-based map 250 merged with the pattern array 240 to form a digital paper hybrid map or NetEyes map 260. A magnified inset delineated by rectangle 280 shows the pattern array 240 in relation to a section of the printed map. The hybrid map or NetEyes map 260 is amenable to precisely delineating the location of hand annotations across a network equipped to receive the delivery of updated digital maps having overlaid image annotations in geographic precision and accuracy to the digital pen 12 hand annotated maps.

The digital pen 12, computer system 120, and hybrid map 260 may be constructed of durable materials to impart a robustness to survive under hazardous conditions. Representations used for augmented reality and map annotations 50, 54, 58, 60 may incorporate the symbols of those designated by Military Standard 2525b.

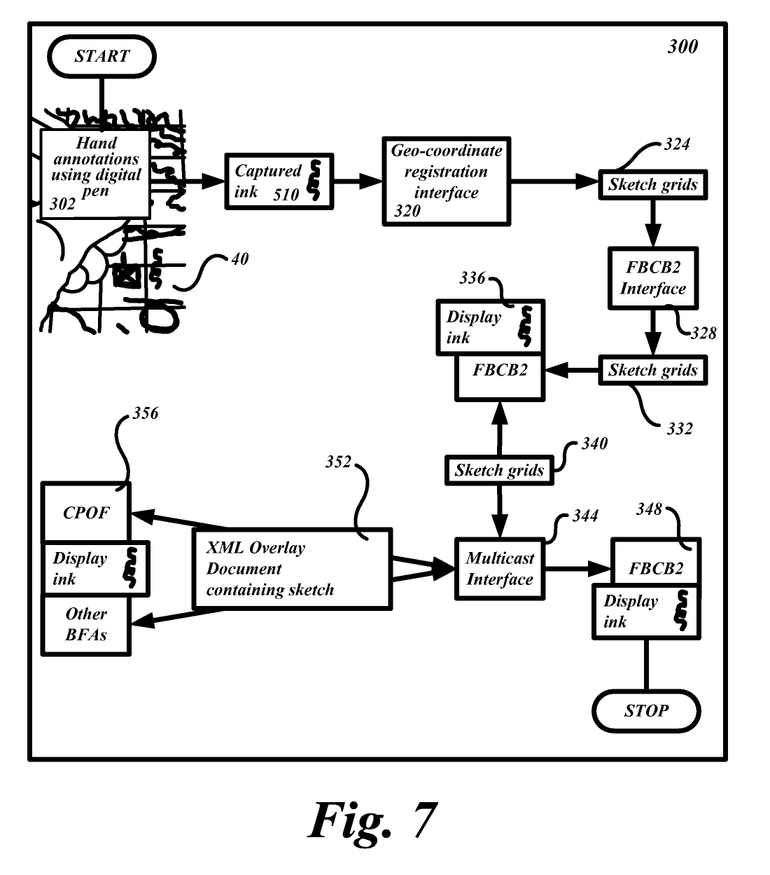

FIG. 7 schematically illustrates a method of using an embodiment of data annotation, recordation, and communication system that converges to a multicast interface of extensible markup language (XML) documents. These XML documents have been updated with annotations in a collaborative process between different users occupying or using the digital pen 12 and/or computer systems 120 at various organizational stations. By way of example, the organizational stations may include the military operational CPOF and the FBCB2 command and control workstations, or other civilian equivalents having similar or different hierarchal authorities. Beginning with process block 302, hand annotations using the digital pen 12 is undertaken on either un-patterned paper, or patternized paper having an array structure similarly functioning to the pattern array 240. At process block 310, at least one, and commonly, a plurality of images of the hand annotations similar to but not limited as described for annotations 50, 54, 58, and 60 are obtained by the scanning camera 18 of the digital pen 12. Thereafter, at process block 320, the geographical coordinates of the hand annotations are determined either from the map-contained pattern array 240, or as calculated by onboard accelerometers and velocimeters of the digital pen 12. Then, the grids are sketched at process block 324 and interfaced at a computer system similar to the computer system 120 located at the command and control workstation at process block 328. The image annotations are then sketched at process block 332 are overlaid as display ink at the command and control workstation at process block 336. Between the command and control workstation at process block 336 and multicast interface block 344, sketch grids are applied as needed at process block 340. At process block 352, XML overlays of the document containing sketch annotations are prepared and provided as display ink at command and control workstation or other BFAs at process block 356. Inputs from the command and control workstation or other BFAs at process block 356 and forwarded to the multicast interface at process block 344. Thereafter, after input from the command and control workstation is forwarded as display ink to the command and control workstation at process block 348 to finish the process 300.

FIG. 8 schematically illustrates symbology projecting onto a paper map as seen from an interior-to-exterior vantage of a first viewer 401. The first viewer 401 adorns a helmet mounted display 70 and gazes through the transparent window 74 to a map 400. Receiving from the computer system 120 signals have augmented reality content, a field of augmented reality symbols are projected onto the transparent monitor window 74 in coordinate registration with the paper map 400 being viewed by the helmet mounted display 70 wearer 401. The paper map 400 provides enhanced resolution due its size and visual details and provides a natural marker or reference loci from which to place or position augmented reality symbols or graphics that are rendered with positional accuracy and with regards to the frame of reference of the particular helmet mounted display 70 wearer 401. The symbology may include force representations and maneuver-related graphics that are projected onto helmet mounted display registered to the map 400. The augmented reality graphics may be selectable, engagable or otherwise or responsive to voice or motion commands expressed by the particular helmet mounted display 70 Wearer 401.

In this illustration, from the vantage point of the helmet mounted display 70 Wearer 401, an interior-to-exterior view of projected symbology is seen by the helmet mounted display 70 Wearer 401. The projected symbology includes a perimeter screen 404, protection domes 408, 412, and 416, defense barrier 420, attack rays 424 emanating from armament source 428, and countermeasure icons 432 are shown overlaid upon the paper map 400. The augmented reality symbols, as described below, may be further manipulated by using combinations of hand gestures, digital pen 12 manipulations, and voice or speech commands. Image files of the augmented reality symbols overlaid upon the paper map 400 may be conveyed to other users having the wearable helmet mounted display 70 as separate stand along image files. The paper map 400 may also be a photograph that is annotated and upon which augmented reality graphic symbols are placed upon with positional accuracy. The updated map or photograph digital file that now includes overlays of digital pen annotations similar to image annotations 150, 154, 158, and 160 and overlays of augmented reality symbols. The digital pen annotations and augmented reality overlays present positional fidelity to the map 400 coordinates is conveyed to central command and control computer systems and/or in memories of decentralized computer systems similar to the computer system 120 or to the onboard memory 24 of the digital pen 12. The digital file updating or version updating may be dynamic and include real or simulated tracks of annotated or augmented reality entities. The digital version of the updated map 400 can be seen by multiple users and include three dimensional models, for example topographic features or points of interest overlaid on a terrain map.

Such augmented reality projected maps provides a tool to implement crisis management involving optimization of situation awareness of personnel concerned with the surveillance of spaces and other regions of interest. The annotations discussed above the augmented reality graphics concerning FIG. 8 provides the ability to draw on a piece of paper and then trough software executable instructions provide computer based systems to recognize what annotations and graphic objects were drawn or sketched. Thereafter, feeding annotation and/or graphic symbols on a basis of the digital objects created or sketched may be subsequently selected, edited, and manipulated by speech recognition, voice recognition, or physical movement, for example, hand gesturing, or any combination thereof. The created digital objects may be projected in the field of view of the see through monitor display 74 viewed by the wearer 78. The digital objects may be projected onto and registered on a map object, a document object, for example a newspaper, a computer aided design CAD drawing, an architectural drawing of a building, a blank piece of paper, or any surface capable of receiving annotations, text, and/or sketches. All annotations, sketches, and/or augmented reality graphics are positioned according to the unique positioning of the viewer's head relative to a given object's surface.

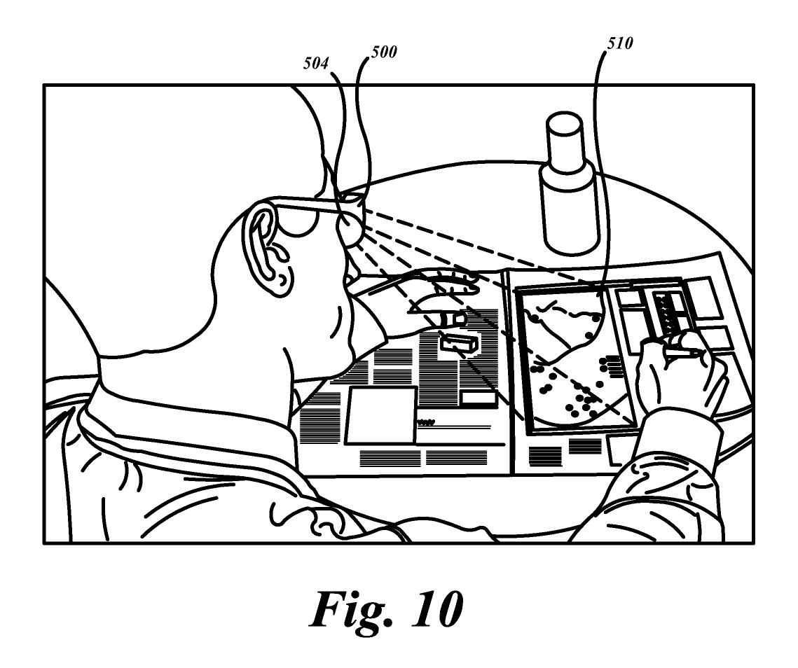

The symbology also provides the ability to track where a viewer's head is relative to the surface, and software executable code provides imagery for projection that is registered to the surface. The projected and registered imagery provides loci to create new objects, digital objects, and to further enhance by surface examination under discrete public surroundings. For example, a user may be looking at a newspaper but creating digital objects that have to do with an upcoming event of some type (see FIG. 10 below). Fiducial markers either upon, along, or within the map 400 and helmet mounted display 70 may be geo-referenced and tracked by geosynchronous satellite mapping technologies or from other locally mounted camera systems (not shown) having sighting and tracking abilities of the map 400 fiducial markers and the helmet mounted display 70 fiducial markers of viewers 401 and 403. Tracking technologies employed may utilize the augmented reality processes provided in the ARToolKit available from ARToolworks, Inc., Seattle, Wash., USA. These ARToolkit tracking technologies may advantageously be programmable to work with the fiducial markers configured to be responsive to hand gesturing, voice, speech and other physical processes to allow interaction, manipulating, editing, and repositioning of the projected realistic depictions, symbols, icons, annotations, alphanumeric and other monitor-presented region or point of interest information.

FIG. 9 schematically illustrates the symbology projected onto the paper map 400 of FIG. 8 as seen from an exterior-to-interior vantage of a second viewer 403. Illustrated here, the second viewer 403 stands diagonally opposite the first viewer 401. The second viewer 403 adorns the helmet mounted display 70 and gazes through the transparent window 74 to the map 400. Receiving from the computer system 120 signals have augmented reality content, the field of augmented reality symbols are projected onto the transparent monitor window 74 in coordinate registration with the paper map 400 being viewed by the helmet mounted display 70 wearer 403. In this illustration, from the vantage point of the helmet mounted display 70 Wearer 403, an exterior-to-interior view of the projected symbology is seen by the helmet mounted display 70 Wearer 403. Due to the tracking of different position of the helmet mounted display 70 wearers 78, the augmented reality symbols along with any image annotations present themselves in accord with a given wearers 78 position relative to the same combat area. Here the protection domes 408, 412, and 416 are shown in front of the defense barrier 420 in which attack rays 428 are blocked, such that the overlaid information is seen from each user's own physical perspective. Both helmet mounted display 70 wearers, that is the first 401 and second 403 viewers, may be presented augmented reality or annotation projections in different views of the combat area and receiving the same updated communication from computer system 120 or the digital pen 12.

FIG. 10 schematically illustrates a sunglass 500 configured with a heads up see-through transparent display 504 being adorned by a sunglass wearer. The sunglass 500 is in signal communication with the digital pen 12 of FIG. 1 and/or the computer system 120 depicted in FIGS. 2-3. Hand annotations similar to annotations 50, 54, 58, and 60 appear as image annotations 150, 154, 158, and 160 and overlaid onto the transparent display 504 in which a document region-of-interest 510 appears within the field of view of the sunglass wearer. The sunglass wearer views image hand annotations and/or augmented reality symbols within the document region-of-interest 510 delineated by the dashed viewing angle lines.

In the field of view of the eyeglass wearer gazing through the transparent display window 504 may inconspicuously visualize military scenario operations while seated in a public arena. For example, the eyeglass wearer may view within the region-of-interest 510 with annotated symbolic depiction communicated from other command and control centers. These command and control centers are designated by way of example in FIG. 7 as C2PC, C4, CPOF, FBCB2 involved with maneuver control system (MCS) related activities being undertaken at a distance away from the eyeglass wearer seated at a restaurant table and receiving annotation updates from a tactical operations center (TOC).

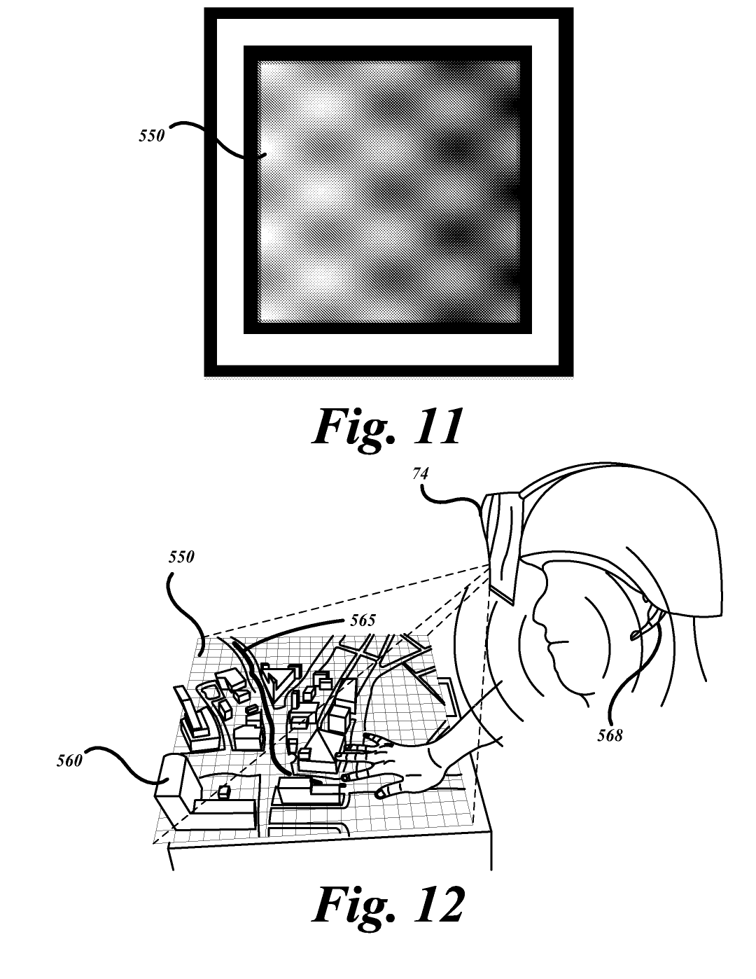

FIG. 11 schematically illustrates a field of hand and speech activation zones 550 projectable upon an object's surface (for example a paper map, a document, a tabletop) that is programmable to be virtually interactable via motion sensors, voice, and speech. A user's hand may move or make gestures that motion sensors (not shown) convey movement that is programmed to signify certain image manipulations, for example, annotation selection or augmented reality object selection, and editing of motion selected annotation or symbology that were selected. Similarly, standardized speech commands or commands from identified voice patterns may be programmed to differentially activate the activation zones and create a virtual display surface. In one embodiment, the user can use a paper map as a fiducial, thereby overlaying relevant digital information to the user. The digital information may be in the form of hand annotations communicated from the digital pen 12 or augmented reality graphics received from the computer system 120. The digital hand annotations or augmented reality graphics are overlaid upon the field activation zones 550. The activation zones 550 may vary in size and position, for example, be along at least a portion of the periphery of planar surface, and/or be within the planar surface. The activation zones 550 may be in the form of a digitizing pad that underlies a document or map, and be differentially responsive to multiple pressure sources, for example touching and sound pressure. The activation zones 550 may exhibit different sound sensitivity conveyed by a microphone spoken in coded phrase or voice intonation, or alternatively, to the sound generated by clapping. The activation zones 550 may be made responsive to types and levels of hand waving or gesturing.

In another embodiment, stereo cameras can be positioned along the periphery of the surface or other position that enables the tracking of a user hand's position relative to a given activation zone 550. Camera tracking data may be conveyed to computer processors to recognize a user's hands for projected annotation and/or graphic object selection and manipulation. The tracking and recognition software enables the overlaid projected and registered augmented reality graphic objects and/or annotations to be selected, rendered and/or further annotated in the virtual space above the activation zones 550. The tracking and recognition software is programmable to respond and recognize defined gestures, while the user of digital paper maps enables the user to share sketches with other, both face-to-face, remotely, and provide for tracking abilities between different users so that each projected and registered overlay may be presented in positional fidelity to a user's given vantage point.

FIG. 12 schematically illustrates a projected cityscape 560 overlaid onto the activation zone field 550 that is in turn overlaid upon onto a paper map, document, tabletop, or any surface suitable to establish orientated boundaries, coordinates, and reference marks for registration of projected virtual objects. The projected cityscape 560 is an example of a virtual model that can be manipulated, edited, or otherwise interacted with by a nearby user equipped with a see through monitor similar to the helmet mounted display 70 described in FIG. 1. The cityscape virtual model 560 is projected onto the activation field 550 and appears as shown from the vantage of the user gazing through the transparent window 74 of helmet mounted display 70. The user has motion sensors (not shown) and wearable speaker-and-microphone device 560 that are in signal communication with the activation field 550. The motion sensors (not shown) may be wearable by the user or placed along the periphery of the map, document, or surface to establish orientation, boundaries, and location of the user's hands relative to the surface to which the activation field 550 and projected virtual model cityscape 560 has be overlaid upon. The nearby user wearing the helmet mounted display 74, gazes through the transparent window 74 and sees the cityscape 560 overlaid upon the hand activatable and annotatable augmented reality symbols placed on a three dimensional model overlaid upon the hand activation zones 550. Points of interest within the projected cityscape 560, for example, a building, street, or other region-of-interest may be highlighted through hand gesturing and/or voice or speech commands and appear orientated with the positional frame of reference or vantage point of the user. Annotation 565 may also be selected for highlighting or undergoing other modifiable editing.

Other embodiment provide for the camera 18 of the digital pen 12 can also be used to track the users' hand gestures allowing them to have natural gesture based input with the virtual content that is overlaid on the real map. For example, the user could point at a certain three dimensional-appearing building or other structure or region of interest within the projected cityscape 560 and use speech commands to get more information about the object being depicted. This allows the hands to naturally occlude the virtual content. Other present users can also see their partner's gestures registered to the digital content that have been superimposed on the activation field 550 that is made part of the paper map 40 or other document or surface. A coordinate tracking system studies the features of a map and determines unique points that can be readily discriminated in a hierarchal manner. For example, four unique points may be selected so that at any given instant, the four unique points can be discriminated no matter how large or small an area of the map is that is visible to the camera 18 of the digital pen 12. Once these points are found they are used to determine the precise position of the user's camera (and their viewpoint) in real time. Using this camera information, virtual information (including live three dimensional data) can be overlaid on the real map and provide data for user tracking. The tracking ability involves calculating user viewpoint from known visual features. In this case, we are using map information; however ostensibly the tracking could also work from camouflage patterns on the hood of a vehicle, or equipment boxes etc. Thus, the technology potentially allows any surface to be used for virtual information display.

As the users begin to draw, digital ink similar to the annotation 565 is seen by the others having equal status, subordinate status, or hierarchal authority. Each viewer sees the virtual model cityscape 560 and annotation 565 orientated to their particular vantage point. One particular embodiment provides responses by overlaying geospatially registered objects on the digital paper in the form of consisting of force representations, maneuver graphics, or other symbolic and pictographic depictions. Using combinations of hand gestures, pen manipulations, and voice commands, the equal status users and users having hierarchal relationships multimodally interact with each other to obtain and maintain situation awareness under changing and mobile conditions. The system structure for annotation updating, communicating and tracking real and virtual document updates is described below.

Other embodiments similar to the projected three-dimensional like virtual objects depicted by the cityscape 560 visualized by the see-through monitor helmet mounted display 70 may be configured for visualization as two-dimensional depictions viewable by personnel not equipped with monitors similar to the helmet mounted display 70 or attached with the computer system 120. For example, optical projectors in signal communication with the digital pen 12 and/or the computer system 120 may project onto the field use map 400 or other document two dimensional representations of the cityscape 560, annotations similar to image annotations 150, 154, 158, 160 and 565, or augmented reality graphics that are two dimensional equivalents graphics 404, 408, 412, 416, 420, 424, 428, and 432 described in FIGS. 1 and 8 above. The optical projectors may be housed in hand held devices, for example in a cell phone and equipped with camera-based tracking so that the two dimensional projections are made with regard to the vantage location or positional frame of reference of the map, document, or surface receiving the two dimensional projections. The two dimensional projections may be registerable on the map 400 or other document without the need for the pattern array 240 depicted in FIGS. 5 and 6 above. The selection, editing, and manipulations of the projected two dimensional content may be made responsive to physical motions, speech and/or voice commands when the projection is made onto a digitizer surface or activatable pad similar to the field activation zones 550 depicted in FIG. 11.

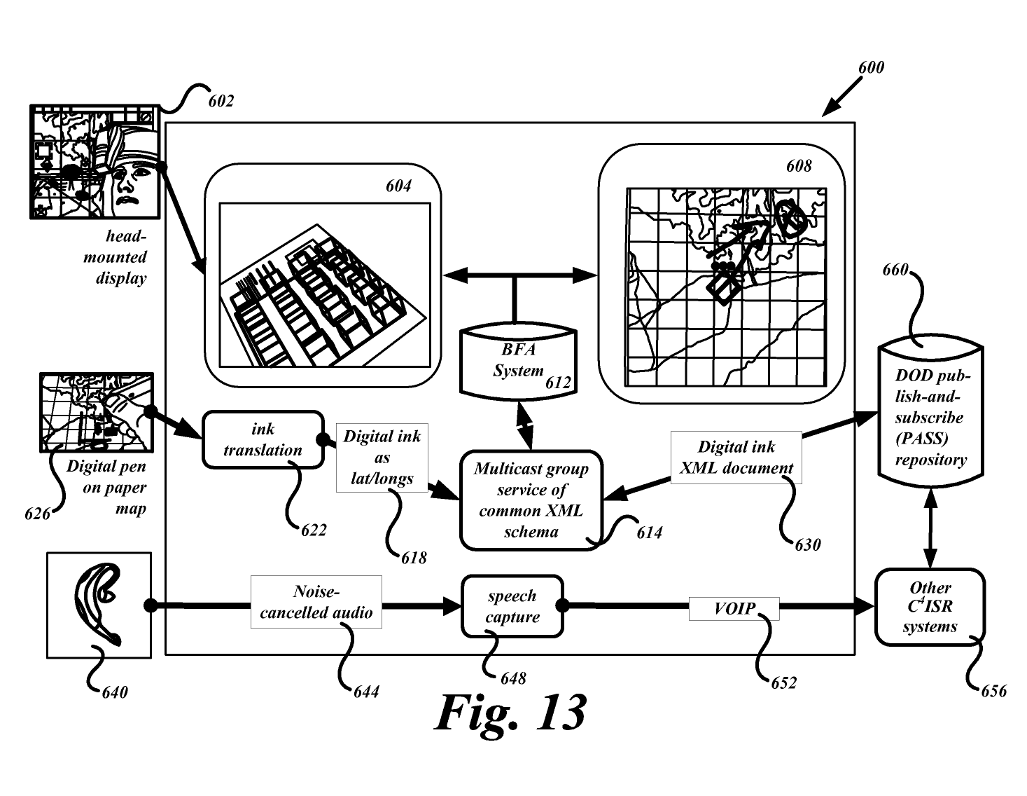

FIG. 13 schematically and pictorially illustrates a system block diagram 600 for annotating, recording, and communicating information. By way of example the system block diagram is described in terms of military applications though the applications of the system 600 is not limited to military uses and scenarios. For example, civilian, business and/or governmental applications may be employed by the system 600.

The system 600 includes three input branches that annotates or otherwise provides annotations and symbols for overlaying on digital maps or overlaying on annotations and graphic symbols on a real map or document object in the field of view of users gazing through a transparent monitor 74 of an HMD 70 or viewing a monitor similar to the computer system 120. One input branch begins with receiving hand or voice manipulated annotations block 602 that is received into a remote user data compilation block 604 that is version updated within the Battle Force Artillery server 612. Another input branch is a digital pen markup map 626 that undergoes ink translation at block 622 and subsequent digital ink registration in terms of latitude and longitude at block 618. Another input branch begins with a speech annotation block 640. Speech annotation may utilize a wearable audio and microphone set. Spoken description from the microphone is washed through or filtered by a noise cancellation audio block 644, followed by speech capture block 648, that then undergoes voice over internet processing (VOIP) at block 652. Thereafter the speech annotation branch is routed through a command-control computer-communication C4ISR system 656 and stored in a centralized Publish-and-Subscribe repository server 660 from which digital ink and XML document markups are made at block 630. The digital files processed through the input branches are then made ready for XML markup and multicast broadcasting at block 614 to the BFA system 612. The server 612 receives and updates digital files at blocks 604 and 608 for retrieval by or sending to the computer system 120 and/or the helmet mounted display 70.

The described systems and methods may be employed during civilian and military emergency operations needing near instantaneous updating of situation awareness information. In military operations, for example, when soldiers are undertaking a dismounted situation assessment, planning, and after action reporting, a team member sketches on a plain looking paper map that is digitally-enabled per pattern array 240 hand annotations. The team member than wirelessly sends image annotations to deployed soldiers equipped with the helmet mounted display 70 for map updating, or alternatively, docks the digital pen 12 in the docking station 200 and updates the computer system 120 near the FOB vehicle 165 for subsequent sharing of image annotations to soldiers equipped with helmet mounted display 70 over a tactical network.

Other embodiments allow for fixed TOC locations to accommodate multiple screens, profligate usage of screen resources, and a drag-and-drop interaction paradigm that, in a preferred embodiment, both source and target windows can be open. Significant improvements can accrue by modifying the interface for wearable operation of CPOF with multimodal (speech/sketch/gesture) interaction to provide a 10× improvement in battlefield employing digital paper similar to the paper map 260, in that updating tactical and strategic information is often less than 30 seconds once the user is in the vehicle. If transmission is wireless, the tactical activity is updated in near-real time.

While the particular embodiments have been illustrated and described, many changes can be made without departing from the spirit and scope of the invention. For example, the annotation, recordation, and communication system is not limited to military situations but also may be used in any scenario requiring rapid user interaction under stressful conditions to which enhanced situation awareness requires. Civilian workers operating in difficult, mobile environments, including emergency workers, construction workers, law enforcement officers, and others, can similarly utilize the same communication, visualization, and collaboration advances that the invention provides for military scenarios. The digital pen need not be limited to ink dispensing mechanisms. For example, a stylus having a cutting burr or a wicking nib releasing an etching solution can be used as alternatives for annotating upon surfaces not amenable to receiving ink. Users can employ any object with unique markings as a display. For example, a user can place a book on a table or vehicle, and have the system register hand annotations and update digital files with equivalent image annotations. Accordingly, the scope of the invention is not limited by the disclosure of the preferred embodiment. Instead, the invention should be determined entirely by reference to the claims that follow.

1. A method for viewing information, the method comprising:
generating a symbol using a digital pen in proximity to an information-carrying-surface having fiducial reference markers operable for orienting a image capturing device;
transmitting the symbol to a processor;
converting the symbol to a realistic depiction representative of the symbol; and
displaying the realistic depiction representative of the symbol on a display device.

2. The method of claim 1, wherein generating the symbol includes drawing the symbol on the information-carrying-surface with the digital pen.

3. The method of claim 1, wherein generating the symbol includes making a hand gesture within a field of view of the image capturing device and in proximity to the information-carrying-surface.

4. The method of claim 1, further comprising:
recording and recognizing voice information while generating the symbol in proximity to the information-carrying-surface.

5. The method of claim 1, wherein the information-carrying-surface includes a micro pattern having micro-dots printed on at least one side of the information-carrying-surface.

6. The method of claim 5, wherein the micro pattern is registered onto the information-carrying-surface for permitting motion tracking of the digital pen relative to a location of the digital pen with respect to the information-carrying-surface.

7. The method of claim 1, wherein transmitting the symbol to a processor includes transmitting data associated with the symbol from the digital pen.

8. The method of claim 1, wherein the fiducial reference markers include objects viewable within a field of view of the image capturing device, the objects selected from the group consisting of graphical objects, alpha-numeric objects, geometric objects, symbolic objects, hand-written objects, printed objects, reflective objects, and contoured objects.

9. The method of claim 1, wherein the fiducial reference markers include objects viewable within the field of view of the image capturing device, the objects selected from the group consisting of mirrors positioned along at least a portion of the periphery of the information-carrying surface, motion sensors positioned along at least a portion of the periphery of the information-carrying surface, and sound sensors positioned along at least a portion of the periphery of the information surface.

10. The method of claim 1, wherein the fiducial reference markers are arranged relative to the information-carrying-surface to provide information related to a spatial orientation of the image capturing device.

11. The method of claim 1, wherein transmitting the symbol to the processor includes sending the signal over a wireless communication link.

12. The method of claim 1, wherein displaying the realistic depiction representative of the symbol on the display device includes displaying the realistic depiction representative of the symbol on a computer monitor.

13. The method of claim 1, wherein displaying the realistic depiction representative of the symbol on the display device includes displaying the realistic depiction representative of the symbol on a head-worn display device.

14. The method of claim 13, wherein displaying the realistic depiction representative of the symbol on the head-worn display device includes displaying the realistic depiction representative of the symbol on a substantially transparent screen.

15. The method of claim 1, wherein displaying the realistic depiction of the object on the substantially transparent screen includes permitting a viewer of the realistic depiction representative of the symbol to view the realistic depiction while maintaining a field of view beyond the substantially transparent screen.

16. The method of claim 1, wherein the image capturing device includes a complementary metal-oxide-semiconductor (CMOS) image sensor.

17. The method of claim 1, wherein the image capturing device includes an image sensor having a charge coupled device (CCD).

18. The method of claim 1, further comprising:
interacting with the realistic depiction representative of the symbol after the realistic depiction is displayed.

19. The method of claim 1, wherein displaying the realistic depiction representative of the symbol on the display device includes projecting the realistic depiction representative of the symbol on the information carrying surface.

20. The method of claim 17, wherein interacting with the realistic depiction includes manipulating the depiction using gestures and voice commands.
